(19) United States
(12) Patent Application Publication
(10) Pub. No.: US 2022/0332604 A1
(43) Pub. Date: Oct. 20, 2022

(54) METHOD, SYSTEM AND DEVICE FOR WASTEWATER TREATMENT

(71) Applicant: BIOTERIA TECHNOLOGIES AB, Täby (SE)

(72) Inventors: Niklas AXELSSON, Täby (SE); Jorma PALOSAARI, Täby (SE); Olle LARSSON-HYTTE, Täby (SE); Johan BARK, Täby (SE); Tiago CARVALHO, Täby (SE); Gustaf STETLER, Täby (SE)

(73) Assignee: BIOTERIA TECHNOLOGIES AB, Täby (SE)

(21) Appl. No.: 17/854,071

(22) Filed: Jun. 30, 2022

Related U.S. Application Data
(62) Division of application No. 17/046,532, filed on Oct. 9, 2020.

(30) Foreign Application Priority Data
Apr. 10, 2018 (SE) 1850401-9

(51) Int. Cl. C02F 1/40; C02F 1/24; C02F 3/02

(52) U.S. Cl. CPC C02F 1/40; C02F 1/24; C02F 3/02; C02F 2101/325

(57) ABSTRACT

A method, a system and an apparatus for wastewater treatment using a combination of separation of fat, oil and grease (FOG) and biological treatment for reducing the amount of fat, oil and grease (FOG) in wastewater with the aid of a liquid culture of microorganisms is provided. In particular, the technology disclosed relates to a method and process for the separation and treatment of FOG, as well as a container tank and an outlet pipe construction adapted for improving the gravimetric FOG separation process and the breaking down of FOG using microorganisms.

### TECHNICAL FIELD

The technology disclosed relates to a method, a system and an apparatus for wastewater treatment using a combination of separation of fat, oil and grease (FOG) and biological treatment for reducing the amounts of FOG in wastewater with the aid of a liquid culture of microorganisms. Specifically, the technology disclosed relates to a method for improved FOG separation and biological treatment of FOG, and a container and an outlet pipe construction adapted for improving the conditions for an efficient gravimetric FOG separation process and the efficiency in the process for degrading FOG using microorganisms.

### BACKGROUND

Generally, the technology disclosed relates to an improved process and equipment adapted for combining a gravimetric separator for the separation of fat, oil and grease (FOG) with a modern bioreactor for biologically breaking down FOG using microorganisms.

This disclosure relates to a combination of processes including separating separable FOG from FOG containing wastewater and biologically treating FOG containing wastewater in a combined FOG separator/bioreactor. The FOG separator is a gravimetric FOG separator function for creating a layer of floating FOG on the surface of the wastewater. The layer of FOG, or FOG/fat cake, is removed from the FOG separator from time to time, for example by emptying the wastewater in the FOG separator.

The bioreactor function is aimed at further reducing the concentration of FOG in the wastewater and is performed by the addition of a liquid culture of microorganisms for breaking down the FOG. The liquid microbe culture is distributed by injecting and distributing air into the biological treatment zone. The air injection continues after the addition of the microbe culture to thereby sustain the bioreactor function.

### Problems with the Prior Art

Most municipalities with municipal sewage nets, receiving wastewater from restaurants and food processing industries, with high fat content in the wastewater, are limiting the fat concentration in the wastewater and demand installation of fat separators to maintain the limit. Fat separators take care of the separable fat, mainly.

Besides the separable fat, the wastewater contains several other substances in dissolved or suspended form as surfactants and alkali from cleaning agents, starch, proteins and fibres from food rests etc. Surfactants and alkali contribute to create stable emulsions with fat. This means that a considerable part of the fat cannot be separated from the wastewater. This well emulsified fat seldom causes problems in the sewage systems.

Fat, in particular, poses a problem for sewer systems because fats are largely insoluble in water and will accumulate over time in drainage pipes, as well as further down the sewer path. These accumulations may not only primarily restrict waste water flow thought the pipe, but can also secondarily restrict water flow by providing a substrate where solid waste can stick. These restrictions may build to the point where the pipe is sufficiently blocked so that wastewater will back up into homes and businesses causing expensive damage and requiring further corrective actions to increase the flow of wastewater. Since most buildings have a single common sewer pipe for all wastewater, the results of a backup of water can be much more unpleasant than the backing up of only water from a sink.

Home and restaurant kitchens, as well as catering and institutional food services can spend thousands of dollars to repair the damage caused by the build-up of FOG. A clogged drain can cause a home to be temporarily inhabitable and force a business to close until the sewer drain is cleared and the damage is cleaned and repaired. The advantages to keeping drains free of any build up before a blockage occurs are clear, however the most common preventative measures often include the use of corrosive chemicals that are dangerous to handle and store, and which are not environmentally sound.

The problems with fat waste are not limited to individual buildings, municipalities also have to contend with the build-up of fat in shared sanitary sewer lines as well as in treatment plants and any other effluent transfer and storage facilities. A municipality's expenses associated with keeping the accumulation of fat minimal through the use of physical methods can be substantial. These costs, however, are preferable to having to clean (if possible) or replace sections of sewer due to the severe accumulation of insoluble waste. These blockages, which are often caused by fat, can cause a sanitary sewer overflow (an “SSO”). An SSO is not only expensive to fix and clean itself, but in the event of an SSO, the governmental authorities and agencies may issue substantial fines to the governing municipality. Additionally, if such an overflow contaminates the drinking water supply, the resulting public health emergency will require, at the least, the issuance of a boil order, where all affected people need to boil water before consuming it. In more extreme cases, boiling may be insufficient and clean water will need to be brought in, or the people moved out, until the water is again made drinkable.

In a fat separator, the fat is separated as a solid comparatively hard cake contaminated with other substances. When the fat separator's space for fat is full, or when the fat cake created on the surface of the wastewater is so thick that the fat separation process is no longer sufficiently efficient, the fat separator, or tank, needs to be emptied, and/or the fat cake created on the surface of the wastewater must be removed, e.g. by emptying the wastewater in the fat separator. Before emptying, the fat cake is typically broken up. In state of the art fat separators, or grease traps, it frequently happens that this breaking up does not became good enough to allow for a substantial portion of the fat in the fat cake to be eliminated. Remaining fat pieces follow the wastewater and gather in the parts of the sewer where the current is weak, and form with other contaminant stoppages, causing at least as large problems as the fat stoppages mentioned.

The separated fat contains large amounts of both un-saponified and saponified fat. Such a mixture is very unfavourable from the reworking point of view, especially as the reworking is disturbed by the contaminants mentioned. Usually the separated fat must be disposed of. Many trials have been done to decompose the fat, to be more easily handled, by using enzymes and several other chemicals. The decomposition products, which are soluble or form stabile dispersions in water, do not cause problems in the sewer and give no problems in the sewage works. Exceptions from this rule are fatty acids, which are said to cause growth of so-called filiform bacteria, which may cause sludge swelling and sludge escape. The success with enzymes has been limited. Chemicals of other kinds are often causing problems in the conduits and in the sewage works.

Trials with living bacteria cultures have been more successful. Especially have cultures with a broad spectrum of starch degrading, protein degrading and fat degrading bacteria shown good results. European patent application No. 0 546 881, French patent application No. 2 659 645 and French patent application No. 2 708 923 treat some different aspects of this technique. Of those publications EP 0 546 881 and FR 2 708 923 relates to the treatment of fat in the diluted form that is found in wastewater, while FR 2 695 645 relates to fat that has been separated from wastewater by flotation.

European patent application No. 0 546 881 refers to an equipment comprising a fat separator provided with baskets containing granulate for retaining of biomass. The baskets are suspended over a ramp for injecting air by nozzles. The fat separator is periodically fed with biomass containing microorganisms from a bioreactor. The addition is done from above at the inlet of the fat separator.

Swedish patent publication 507 020 (9601090-6) and PCT/SE97/00486 (WO 97/34840), with the same assignee as the present application, refers to a developed fat separator, where addition of bioculture is done in an intermediate layer between the fat phase and the sludge phase with the aid of a pipe system extending along the main part of the separator.

Systems according to Swedish patent publication 507 020 (9601090-6) and PCT/SE97/00486 (WO 97/34840) reduce the fat volume, but require emptying at comparatively short intervals. Restaurants are as a rule in areas with high people density and often in old settlements, where heavy transports have difficulties to pass. The comparably low value of the recovered fat is seldom enough to compensate for the troubles. European patent application No. 1 332 113, with the same assignee as the present application, addresses the problem with the disturbance that poisoning and degeneration of a bio-culture may cause, by suggesting a well-planned distribution of the bio-culture, to renew the colonies in the whole system continuously.

EP 1 332 113 describes a process for separating separable fat from wastewater and reducing the amount of separable fat which needs to be taken care of. In the process, a specially equipped container is used. The equipment makes it possible to use the container alternatively as a separator and bioreactor. During a separator phase, fat is collected in the usual way in the, for separated fat intended, volume in the container. After a changeover to bioreactor function this fat is biologically broken down wholly or partly. To start the breaking down of FOG, a liquid culture of suitable microorganisms is added at the changeover to bioreactor function. The bio-culture is mixed efficiently with the content in the container by air injection in an intermediate layer that lays over the sludge layer and under the floating fat layer in the fat separator/bio-reactor proper. To maintain the biological process and intensify the break down and mixing, air should be blown in during the entire time when no new wastewater is added to the container. The changeover to separator function is done by shutting off the air injection.

In EP 1 332 113, the fat separation function and the bioreactor function are used at different periods of a 24-hour time cycle. When fat containing wastewater is added, the system acts as a conventional fat separator and corresponds to all demands that may be made upon a well-functioning one. During the periods when there is no addition of wastewater, the function of the equipment is changed over to correspond to a modern bioreactor, which achieves an intensive biological break down of all available organic material. Typically, the transition comprises addition of a liquid starter culture containing a suitable mixture of living microorganisms, which are evenly distributed in the bioreactor with the aid of air injection. The reaction is supported by continued air injection until the equipment's separator function is needed once again.

### SUMMARY

The technology disclosed describes a system, a container or container tank, an outlet pipe construction and a method for treatment of food waste using a combination of gravimetric fat, oil and grease (FOG) separation and biologically breaking down FOG using microorganisms for reducing the amount of FOG in wastewater contained in the tank. In the technology disclosed, the microbe culture, e.g. a liquid microbe culture, is added and distributed by air injection of an oxygen-containing gas such as air into a biological treatment zone of a container tank.

The method of the technology disclosed comprises injecting high amounts of oxygen-containing gas, e.g. air, per unit of time into the wastewater contained in the biological treatment zone to achieve a high bioprocess productivity, or a high bioprocess efficiency, during periods when no wastewater, or a small inflow of wastewater, per unit of time is added to the container tank.

In the container tank of the technology disclosed, the gravimetric FOG separation function and the bioreactor function are both maintained above certain levels of activity over a 24-hour time cycle. According to the method of the technology disclosed and when high amounts of FOG containing wastewater is added, the injection and distribution system in the biological treatment zone of the container tank is injecting small amounts of oxygen-containing gas, e.g. air, to increase the growth of microorganisms for improved biological activity, or improved biological treatment efficiency, during periods when no wastewater, or a small inflow of wastewater, per unit of time is added to the container. During periods when there is no or small amounts of addition of wastewater, the function of the wastewater equipment or container essentially correspond to a modern bioreactor running at full scale, and which achieves an intensive biological break down of fat, oil and grease (FOG) In example embodiments, the transition between periods of high and no or low amounts of wastewater added may comprise the addition of a liquid starter culture containing a suitable mixture of living microorganisms, which are evenly distributed in the reactor with the aid of the air injection.

The technology disclosed proposes a method including the additional action of injecting low amounts of air per unit of time during periods when high amounts of wastewater per unit of time is added to, or flowing into, the container tank, thereby improving the oxygenation conditions to increase the growth of microorganisms for improved biological activity and breaking down of FOG. According to at least one objective of the method of the technology disclosed, the injection of low amounts of air per unit of time during periods when high amounts of wastewater are added to the container is used to increase the growth of microorganisms for improved biological activity and biological treatment efficiency during periods when no wastewater, or a small inflow of wastewater, per unit of time is added to, or flowing into, the container tank.

In example embodiments of the technology disclosed and depending on the size of the container tank used and/or the maximum volume of wastewater that may be contained in the container tank used, the high amounts of wastewater added to, or flowing into, the container tank may be defined by an average value within the range from 2 liters of wastewater per second to 20 liters of wastewater per second averaged over a continuous period of at least 20 minutes.

In example embodiments of the technology disclosed and depending on the size of the container tank used and/or the maximum volume of wastewater that may be contained in the container tank used, the small inflow of wastewater added to, or flowing into, the container tank may be defined by an average value which is below a value within the range from 0.1 liters of wastewater per second to 1 liter of wastewater per second averaged over a continuous period of at least 20 minutes.

In example embodiments of the technology disclosed, the total amount of wastewater added to the container during at least one first period when high amounts of wastewater are added to, or flowing into, the container is at least three times the total amount of wastewater added to the container during at least one second period when no wastewater, or a small inflow of wastewater, per unit of time is added to the container. The at least one first period for adding high amounts of wastewater per unit of time to the biological treatment zone may be defined by at least one continuous period covering at least two hours in total of a continuous, or coherent, 24 hours period. The at least one second period when low amounts of wastewater are added to, or flowing into, the biological treatment zone per unit of time may be defined by at least one continuous period covering at least two hours in total within the same continuous, or coherent, 24 hours period, or time window.

In embodiments, the low amounts of oxygen-containing gas, such as air, per unit of time during periods when high amounts of wastewater are added to the container may further be at a level which is adapted for achieving a high combined bioprocess productivity and FOG separation efficiency in the biological treatment zone during periods when higher amounts of wastewater per unit of time is added to the container.

According to the method of the technology disclosed, the low amounts of injected oxygen-containing gas such as air per unit of time during periods when greater amounts, or high amounts, of wastewater per unit of time is added to the container is less than the amount injected per unit of time during periods when no wastewater, or a small inflow of wastewater, is added to the container. The proposed injection of oxygen-containing gas, e.g. air, during periods when high amounts of wastewater per unit of time is added according to the technology disclosed have the purpose of improving the oxygenation conditions in the container to increase the growth of microorganisms for increased biological activity and breaking down of FOG, yet the amount of oxygen-containing gas may be adapted to be below a certain injection rate in order to avoid creating excessive additional turbulence in the biological treatment zone causing an undesired level of decrease in the level of FOG separation efficiency during periods when high amounts of wastewater per unit of time is added to the tank.

According to the above-mentioned procedure, and as proposed by the technology disclosed, the rate for injecting the oxygen-containing gas may be carefully adapted to be between two different injection rate levels to thereby provide for improved oxygenation conditions and a more efficient biological treatment process during periods when no wastewater, or a small inflow of wastewater, is added to the tank, yet avoiding an injection of oxygen-containing gas, e.g. air, that cause too much, i.e. excessive, additional wastewater turbulence in the biological treatment zone during periods of adding greater amounts of wastewater to the container tank. An injection procedure that cause excessive additional turbulence in the wastewater in the biological treatment zone of the tank could impair the gravimetric FOG separation efficiency in the biological treatment zone, which in turn could lead to a decrease in the FOG separation and an undesirable increase, e.g. a temporary increase, in the proportion or concentration of fat, or FOG, in the wastewater flowing out of the biological treatment zone.

The above-mentioned undesirable level of decrease in the gravimetric FOG separation efficiency may be defined by a level above which the concentration of FOG, e.g. defined in milligrams of hydrocarbons per liter of wastewater, flowing out through an outlet pipe portion of the container during periods when high amounts of wastewater is added to the biological treatment zone is above a certain threshold concentration. In example embodiments, this certain concentration is a threshold limit concentration set for the container to avoid pipe clogging caused by a high concentration of FOG or hydrocarbons, in the pipe system, or wastewater pipe system or sewer pipe system, receiving wastewater flowing out from the container tank of the technology disclosed, and other similar containers contributing to the amount of FOG in the pipe system.

According to embodiments of the technology disclosed, the low amounts of oxygen-containing gas or air injected per unit of time, injected during periods when greater amounts of wastewater per unit of time is added, is kept below injection rate levels that cause excessive turbulence in the biological treatment zone, which in turn could lead to that not sufficient amounts of FOG is separated from the wastewater by ascending, or floating up, to the wastewater surface. If the amounts of FOG ascending, or floating up, to the wastewater surface is not sufficiently large, this leads to an impaired gravimetric FOG separation efficiency and that the concentration of FOG leaving the biological treatment zone by flowing out through its outlet pipe construction is too high.

According to embodiments of the technology disclosed, the low amounts of injected oxygen-containing gas or air per unit of time, injected during periods when greater amounts of wastewater per unit of time is added, is less than a third of the amount injected per unit of time during periods when no wastewater, or a small inflow of wastewater, is added to the container tank.

According to embodiments of the technology disclosed, the low amount of injected oxygen-containing gas or liquid per unit of time, injected during periods when greater amounts of wastewater per unit of time is added, is at least four times smaller than the amount injected per unit of time during periods when no wastewater, or a small inflow of wastewater, is added to the container tank.

According to embodiments of the method of the technology disclosed, the method includes operating the container tank so that the overall efficiency of the bioprocess in the tank over a 24 hours period is improved in that the proposed multi-level injection procedure is improving the productivity of the bioprocess, or bioprocess activity, above a certain level during periods when greater amounts of wastewater is added to the tank. The introduction of a procedure where oxygen-containing gas is injected also during periods when greater amounts of wastewater is added to the container tank provides an improved overall bioprocess in that the oxygenation conditions is improved for increasing the growth of microorganisms, thereby the bioprocess activity, or productivity, is faster reaching a higher level during periods when no wastewater, or a small inflow of wastewater, is added.

Hence, the proposed injection of low amounts of air during a period when greater amounts of wastewater is added to the container tank to improve the oxygenation conditions and increased growth of microorganisms provides for an increased bioprocess activity, or productivity, during the entire subsequent period when no wastewater, or a small inflow of wastewater, is added in that the bioprocess activity, or productivity, is faster reaching higher levels after the changeover from injecting low amounts of air to injecting high amounts of air per unit of time. However, the injection rate and distribution of air should also be kept below a certain level to avoid too high injection rates that cause too much turbulence in the wastewater during periods when high amounts of wastewater is added to the container tank. Excessive turbulence following the injection of too much air per unit of time when high amounts of wastewater per unit of time is flowing into the biological zone of the container will lead to a significant decrease in the gravimetric FOG separation efficiency and that a too high concentration of FOG is flowing out of the biological treatment zone due to the significant decreased gravimetric FOG separation efficiency.

The flow-through of added wastewater to a container, which comprises an inlet and an outlet, produces a turbulence in the wastewater in the biological treatment zone of the container. When high amounts of wastewater per unit of time is added to, or flowing into, the container tank, the flow-through of wastewater in the container tank is producing high levels of turbulence in the wastewater and, vice versa, when low amounts of wastewater per unit of time is added to, or flowing into, the container tank, the flow-through of wastewater is producing low levels of turbulence in the wastewater.

In an air injection system using nozzles, and optionally plates, for air distribution according to embodiments of the technology disclosed, there is a correlation between the amount of air, or oxygen-containing gas, injected per unit time and the additional turbulence created following the injection of air. The additional turbulence is the additional turbulence caused and derived from the injection of air in addition to the turbulence produced from the flow-through of wastewater flowing from the inlet to the outlet of the container tank. A high amount of air injected per unit time creates high additional turbulence in the wastewater in the biological treatment zone, and vice versa.

The technology disclosed describes a method for treatment of food waste with the aid of a liquid culture of microorganisms in an optimized bioprocess used in a container for reducing the amount of fat, oil and grease (FOG) in wastewater. The method is comprising operating the container using multiple injection rates for injecting and distributing air into the wastewater in a biological treatment zone of the container tank, including the steps of:
a) receiving wastewater through an inlet of a container tank, wherein the amount of received wastewater added per unit of time to a biological treatment zone of the container tank varies over a continuous period of 24 hours;
b) providing for the separation of FOG from the wastewater to form a layer of FOG on the surface of the wastewater in the biological treatment zone, wherein the layer of FOG is formed on the surface in a gravimetric FOG separation process in that FOG has a lower density than water;
c) adding a liquid culture of microorganisms for breaking down FOG, where the liquid culture of microorganisms is distributed by injecting and distributing air into a biological treatment zone of the container tank to achieve an efficient oxygenation and mixing of the wastewater for improved biological activity and biological treatment efficiency; the injection and distribution of air comprises:
d) injecting high amounts of air per unit of time into the wastewater in the biological treatment zone to achieve high biological treatment efficiency and a high level of breaking down of FOG during periods when no wastewater, or a small inflow of wastewater per unit of time, is added to the biological treatment zone; where the method further comprises operating the container tank using a plurality of different injection rates for injecting air into the wastewater in the biological treatment zone, including:
e) injecting low amounts of air per unit of time during periods when high amounts of wastewater per unit of time is added to the biological treatment zone, thereby enhancing, or improving, the oxygenation conditions to increase the growth of microorganisms for improved biological activity and breaking down of FOG.

In certain embodiments of the technology disclosed, the above-mentioned low amounts of injected air per unit of time during periods when high amounts of wastewater per unit of time is added to the biological treatment zone is adapted to increase the concentration of microorganisms for enhanced, or improved, biological activity and breaking down of FOG during periods when no wastewater, or a small inflow of wastewater per unit of time, is added to, or flowing into, the biological treatment zone.

In certain embodiments of the technology disclosed, the above-mentioned low amounts of injected air per unit of time is adapted to be at least two times less per unit of time than said high amounts of injected air per unit of time, thereby being adapted to be below an injection rate level above which the turbulence in the wastewater cause excessive additional turbulence in the wastewater leading to an undesirable level of decrease in the gravimetric FOG separation efficiency in the biological treatment zone during periods when high amounts of wastewater per unit of time is added, or flowing into, the biological treatment zone of the tank.

In certain embodiments of the technology disclosed, the above-mentioned injection of low amounts of air per unit of time during periods when high amounts of wastewater per unit of time is added to the biological treatment zone is adapted to improve the oxygenation conditions to stimulate an increase in the concentration of microorganisms during periods when high amounts of wastewater per unit of time is added so that the biological activity and breaking down of FOG is more rapidly reaching higher levels during periods when no wastewater, or a small inflow of wastewater per unit of time, is added, or flowing into, the biological treatment zone of the tank, i.e. faster reaction rates is achieved.

In certain embodiments of the technology disclosed, the above-mentioned low amounts of air injected per unit of time during periods when high amounts of wastewater per unit of time is added to the biological treatment zone is adapted to be less than a level creating an excessive additional turbulence in the wastewater that cause an undesirable level of decrease in the gravimetric FOG separation efficiency in the biological treatment zone during periods when high amounts of wastewater per unit of time is added to the tank.

In certain embodiments of the technology disclosed, the above-mentioned low amounts of air injected per unit of time is adapted so that the combined gravimetric FOG separation and biological process efficiency from said enhanced oxygenation conditions is keeping the accumulation of FOG and the FOG thickness increase in the layer of FOG in the biological treatment zone at a low level also during periods when high amounts of wastewater per unit of time is added.

In certain embodiments of the technology disclosed, the above-mentioned low amounts of injected air per unit of time is adapted to be less than a certain level above which the additional turbulence in the wastewater produced by the injection of low amounts of air causes an undesirable level of decrease in the gravimetric FOG separation efficiency in the biological treatment zone. The undesirable level of decrease in the gravimetric FOG separation efficiency may be defined by a level above which the decrease in the gravimetric FOG separation efficiency leads to that the concentration of FOG flowing out through an outlet pipe portion of the container tank during periods when high amounts of wastewater is added to the biological treatment zone is above a certain concentration during a certain period of time. Said certain concentration of FOG, e.g. defined in milligrams of hydrocarbons per liter of wastewater, in the wastewater flowing out through the outlet pipe portion may in example embodiments of the technology disclosed be a threshold limit concentration set to avoid pipe clogging caused by a high concentration of FOG in the pipe system receiving said wastewater flowing out from the container tank.

In certain embodiments of the technology disclosed, the above-mentioned low amounts of injected air per unit of time is adapted so the accumulation of FOG and the FOG thickness increase in the layer of FOG in the biological treatment zone is keeping the thickness of the layer of FOG below a certain thickness threshold for a certain period of time.

In certain embodiments of the technology disclosed, the above-mentioned low amounts of injected air per unit of time is adapted above a certain level to keep the thickness of the layer of FOG in the biological treatment zone to be thinner than 20 cm for a period of operating the container tank which is longer than 6 months.

In certain embodiments of the technology disclosed, the above-mentioned low amounts of injected air per unit of time is adapted above a certain level to keep the thickness of the layer of FOG in the biological treatment zone to be thinner than 20 cm for a period of operating the container tank which is longer than one year.

In certain embodiments of the technology disclosed, the above-mentioned low amounts of injected air per unit of time during periods when high amounts of wastewater per unit of time is added is less than a third of the high amounts injected per unit of time during periods when no wastewater, or a small inflow of wastewater, is added to the biological treatment zone.

In certain embodiments of the technology disclosed, the above-mentioned low amounts of injected air during periods when high amounts of wastewater added is at least four times less than the amounts injected per unit of time during periods when no wastewater, or a small inflow of wastewater, is added to the biological treatment zone.

In certain embodiments of the technology disclosed, the above-mentioned high and low amounts of injected air per unit of time are adapted to be at levels so that the wastewater turbulence intensity in the biological treatment zone during periods when high amounts of wastewater per unit of time is added to the biological treatment zone is at least two times less than the wastewater turbulence intensity during periods when no wastewater, or a small inflow of wastewater per unit of time, is added to the biological treatment zone.

The method of the technology disclosed may comprise operating the container tank so that the accumulation of FOG, and the FOG thickness increase in the layer of FOG, in the biological treatment zone is decreased in that the plurality of different injection rates are adapted to provide an increase in the biological activity and the breaking down of FOG above a certain level during periods when high amounts of wastewater per unit of time is added to the tank, thereby providing for the biological process efficiency and breaking down of FOG faster reaching higher levels during periods when no wastewater, or a small inflow of wastewater, is added, i.e. faster reaction rates is achieved. The plurality of different injection rates may then be adapted to avoid an injection of air at a level above which too much additional turbulence in the wastewater is produced which leads to an undesirable level of decrease in the gravimetric FOG separation efficiency which, in turn, causes an increase in the concentration of FOG flowing out through an outlet pipe portion of the container tank. The injection of air may be adapted to provide a concentration of FOG, e.g. defined in milligrams of hydrocarbons per liter of wastewater, flowing out through an outlet pipe portion of the biological treatment zone of the container tank which is below a certain threshold concentration during periods when high amounts of wastewater per unit of time is added to the biological treatment zone. The threshold concentration of FOG may then be at least one of the concentration of FOG, or milligrams of hydrocarbons per liter of wastewater, flowing out through an outlet pipe portion at a certain time instant and the average concentration of FOG, or milligrams of hydrocarbons per liter of wastewater, over a certain time period.

The method according to the technology disclosed is adapted for allowing air injection during periods when high amounts of wastewater are added to the container, thereby improving the oxygenation conditions in the biological treatment zone of the container. The improved oxygenation conditions have the effect that the efficiency or intensity of the biological treatment process is increased as the growth of microorganisms is stimulated. Benefits with the proposed method of further stimulating the growth of microorganisms by air injection also when high amounts of wastewater are added include that the increase in the thickness of the layer of FOG on the surface of the wastewater over the period of e.g. a week is reduced, which in turn have the effect that the FOG cake needs to be removed from the container tank less frequently. According to embodiments of the technology disclosed, the FOG cake is removed by emptying the wastewater in the container tank. In other example embodiments of the technology disclosed, the FOG cake may be separately recovered and removed from the tank without emptying all of the wastewater in the tank. Other advantages of the technology disclosed include that the total amounts of microorganisms needed to be added to the biological treatments to sustain the biological treatment process is reduced as the growth of microorganisms is also sustained by the injection of air during periods when high amounts of wastewater are added to the biological treatment zone/container.

In certain example embodiments, the period for adding high amounts of wastewater per unit of time to the biological treatment zone is at least one continuous period covering between 2 and 20 hours in total over a 24 hours period, and the period for adding low amounts of wastewater to the biological treatment zone per unit of time is at least one continuous period covering between 4 and 20 hours in total over the same 24 hours period, or 24 hours time window.

In certain example embodiments, and as air has a lower density than FOG and FOG has a lower density than water, the above-mentioned enhancement of the oxygenation conditions from the injection of low amounts of air per unit of time during periods when said high amounts of wastewater per unit of time is added to the biological treatment zone is also improving the gravimetric FOG separation efficiency in that the enhanced oxygenation conditions improves the carrying capacity for moving FOG in the wastewater in a direction towards the layer of FOG on the surface of the biological treatment zone.

In certain example embodiments, the above-mentioned injection of low amounts of air per unit of time is at a level improving the biological activity and the breaking down of FOG in the biological treatment zone to be at a level providing for a reduction of the thickness of the layer during periods when no wastewater, or a small inflow of wastewater per unit of time, is added to the biological treatment zone, wherein said level of biological activity achieved is keeping the increase of the thickness of the layer of FOG in the biological treatment zone to be less than 5 cm over a period of 2 months.

In certain example embodiments, the above-mentioned low and high amounts of air per unit of time are the average amounts of air per unit of time injected over a time period of at least two hours.

In certain example embodiments, the layer of FOG is reduced during a major portion of the entire continuous period of time when no wastewater, or a small inflow of wastewater per unit of time, is added to the biological treatment zone. The entire continuous period of time may then be covering between 4 and 20 hours in total over a 24 hours period.

In certain example embodiments, the above-mentioned injection of low amounts of air per unit of time is adapted to be above a level above which the reduction of said layer of FOG during certain periods of time over a 24 hours period is enabling a frequency for removing a layer of FOG from the container tank to be reduced to an occurrence of less frequently than once per year. The layer of FOG may typically then have a certain thickness, typically between 10 and 20 cm, when it is removed from the container tank. In example embodiments of the technology disclosed, the FOG cake is removed by emptying the wastewater in the container tank together with the FOG cake. In other example embodiments, the FOG cake may be separately recovered and removed from the surface of the wastewater in the biological treatment zone of the container tank without emptying all of the wastewater in the tank.

In certain example embodiments, the above-mentioned low amounts of wastewater per unit of time added to the biological treatment zone is at least four times less than the high amounts of wastewater added per unit of time. The low and high amounts of wastewater added per unit of time may then be the average amounts of wastewater added per unit of time over a time period of at least two hours.

According to example embodiments for implementing the technology disclosed, the total amount of wastewater added to the container during at least one first period when high amounts of wastewater are added to the container is at least three times the total amount of wastewater added to the container during at least one second period when no wastewater, or a small inflow of wastewater, per unit of time is added to the container. As an example, the at least one first period for adding high amounts of wastewater per unit of time to the biological treatment zone is defined by at least one period covering at least two hours in total of a continuous 24 hours period. The at least one second period when low amounts of wastewater are added to the biological treatment zone per unit of time is defined by at least one period covering at least two hours in total within the same continuous 24 hours period.

According to another example embodiment for implementing the technology disclosed, the total amount of wastewater added to the container during at least one first period when high amounts of wastewater are added to the container is at least five times the total amount of wastewater added to the container during at least one second period when no wastewater, or a small inflow of wastewater, per unit of time is added to the container. As an example, the at least one first period for adding high amounts of wastewater per unit of time to the biological treatment zone is defined by at least one period covering at least two hours in total of a continuous 24 hours period. The at least one second period when low amounts of wastewater are added to the biological treatment zone per unit of time is defined by at least one period covering at least two hours in total over the same continuous 24 hours period.

According to yet another example embodiment, the total amount of wastewater added to the container during at least one first period when high amounts of wastewater are added to the container is at least ten times the total amount of wastewater added to the container during at least one second period when no wastewater, or a small inflow of wastewater, per unit of time is added to the container. As an example, the at least one first period for adding high amounts of wastewater per unit of time to the biological treatment zone is defined by at least one period covering at least two hours in total of a continuous 24 hours period. The at least one second period when low amounts of wastewater are added to the biological treatment zone per unit of time is defined by at least one period covering at least two hours in total over the same continuous 24 hours period.

The technology disclosed further describes a container for receiving wastewater and which is configured for both separating and biologically breaking down fat, oil and grease (FOG) to reduce the amount of FOG in the wastewater. The container tank may then comprise the following features:
f) an inlet for receiving wastewater;
g) a distribution system for adding a microbe culture of microorganisms to the wastewater for biologically breaking down FOG in the wastewater, said microbe culture of microorganisms is added to the wastewater in a biological treatment zone of the container tank;
h) an air injection and distribution system for injecting and distributing air into the wastewater in the biological treatment zone to achieve an efficient oxygenation and mixing of the wastewater for increasing the biological activity and level of breaking down of FOG; and
i) an outlet pipe construction comprising at least one inlet pipe portion and at least one outlet pipe portion adapted for leading wastewater into the inlet portion and out of the biological treatment zone through the at least one outlet portion, wherein said at least one inlet pipe portion is provided to be positioned facing upwards at an angle in relation to at least one of the gravitational horizontal plane and the surface of the wastewater in the biological treatment zone.

In example embodiments, the above-mentioned positioning of the inlet portion of the outlet pipe construction may be in an upwards facing angle adapted to increase the gravimetric FOG separation efficiency in the biological treatment zone, thereby being adapted for reducing the proportion of FOG in the wastewater flowing out of the biological treatment zone through the outlet pipe portion of the outlet pipe construction.

In example embodiments, the above-mentioned positioning of the inlet portion of the outlet pipe construction in an upwards facing angle is adapted to improve the gravimetric FOG separation efficiency in that FOG has a lower density than water and wastewater moving in a direction towards the surface contains higher amounts of FOG than wastewater moving in the opposite direction. The positioning of the inlet portion of the outlet pipe construction may be in an upwards facing angle which is further adapted to provide for a longer median retention time for the wastewater in the biological treatment zone, thereby further improving the gravimetric FOG separation efficiency in order to keep the concentration of FOG, e.g. defined in milligrams of hydrocarbons per liter of wastewater, in the wastewater flowing out of the biological treatment zone through the outlet pipe portion below a certain concentration during periods when high amounts of wastewater is added to the biological treatment zone. The certain concentration may then be a threshold limit concentration set to avoid pipe clogging caused by a high concentration of FOG, or milligrams of hydrocarbons per liter of wastewater, in the pipe system receiving wastewater flowing out from the container tank.

In example embodiments, the above-mentioned angle of the upwards facing angle of the inlet portion in relation to at least one of the horizontal gravitational plane and the surface of the wastewater in the biological treatment zone is adapted so that the concentration of FOG, or concentration of hydrocarbons, in the wastewater flowing out of the biological treatment zone through the outlet pipe portion is kept below a threshold limit concentration during periods when high amounts of wastewater is added to the biological treatment zone. In example embodiments of the technology disclosed, the threshold limit concentration is set to a specific value between 10 and 100 milligrams of hydrocarbons per liter of wastewater.

In example embodiments, the above-mentioned at least one inlet pipe portion is positioned at an upwards facing angle in relation to the surface of the wastewater so that the central axis of the opening of the inlet pipe portion for the inflow of wastewater into said outlet pipe construction is at an angle within an angle range of 5-60 degrees in relation to at least one of the horizontal gravitational plane and the surface of the wastewater in the biological treatment zone.

In example embodiments, the above-mentioned at least one inlet pipe portion is positioned at an upwards facing angle in relation to the surface of the wastewater so that the central axis of the opening of the inlet pipe portion for the inflow of wastewater into said outlet pipe construction is at a 15 degrees angle, or close to a 15 degrees angle, to at least one of the horizontal gravitational plane and the surface of the wastewater in the biological treatment zone.

The above-mentioned container according any of the embodiments of the technology disclosed is adapted for allowing air injection during periods when high amounts of wastewater are added to the container, thereby improving the oxygenation conditions in the biological treatment zone of the container. The improved oxygenation conditions have the effect that the efficiency or intensity of the biological treatment process is increased as the growth of microorganisms is stimulated. Benefits with the proposed container, which is enabling air injection also when high amounts of wastewater are added, include that the increase in the thickness of the layer of FOG on the surface of the wastewater over the period of e.g. a week is reduced, which in turn have the effect that the FOG cake needs to be removed from the container tank less frequently. In example embodiments of the technology disclosed, the FOG cake is removed by emptying the wastewater in the container tank together with the FOG cake. In other example embodiments, the FOG cake may be separately recovered and removed from the surface of the wastewater in the biological treatment zone of the container tank without emptying all of the wastewater in the tank. Other advantages of the technology disclosed include that the total amounts of microorganisms needed to be added to the biological treatments to sustain the biological treatment process is reduced as the growth of microorganisms is also sustained by the injection of air during periods when high amounts of wastewater are added to the biological treatment zone/container.

The technology disclosed further describes an outlet pipe construction for use in a container tank for receiving and biologically breaking down and separating fat, oil and grease (FOG) in the wastewater. In example embodiments, the outlet pipe construction comprises at least one inlet pipe portion and at least one outlet pipe portion for leading wastewater from the container tank, where the at least one inlet pipe portion is adapted to be positioned facing upwards at an angle in relation to at least one of the horizontal gravitational plane and the surface of the wastewater contained in a biological treatment zone of the container tank, thereby providing for an outlet pipe construction which is configured to increase the gravimetric FOG separation efficiency in the biological treatment zone.

In example embodiments, the above-mentioned positioning of the inlet portion of the outlet pipe construction is in an upwards facing angle adapted to improve the gravimetric FOG separation efficiency in that FOG has a lower density than water and wastewater moving in a direction towards the surface contains higher amounts of FOG than wastewater moving in the opposite direction.

In example embodiments, the above-mentioned positioning of the inlet portion of the outlet pipe construction is in an upwards facing angle is further adapted to provide for a longer median retention time for the wastewater in the biological treatment zone, thereby further improving the gravimetric FOG separation efficiency.

In example embodiments, the above-mentioned inlet portion in an upwards facing angle is adapted for keeping the concentration of FOG in the wastewater flowing out of the biological treatment zone through the outlet pipe portion below a certain concentration during periods when high amounts of wastewater per unit of time is added to the biological treatment zone.

In example embodiments, the above-mentioned at least one inlet pipe portion is positioned at an upwards facing angle in relation to the surface of the wastewater so that the central axis of the opening of the inlet pipe portion for the inflow of wastewater into said outlet pipe construction is at an angle within an angle range of 5-60 degrees to at least one of the horizontal gravitational plane and the surface of the wastewater in the biological treatment zone.

In example embodiments, the above-mentioned at least one inlet pipe portion is positioned at an upwards facing angle in relation to the surface of the wastewater so that the central axis of the opening of the inlet pipe portion for the inflow of waste water into said outlet pipe construction is at a 15 degrees angle, or close to a 15 degrees angle, to at least one of the horizontal gravitational plane and the surface of the wastewater in the biological treatment zone.

The above-mentioned outlet pipe construction according any of the embodiments of the technology disclosed is adapted for allowing air injection during periods when high amounts of wastewater are added to the container, thereby improving the oxygenation conditions in the biological treatment zone of the container. The improved oxygenation conditions have the effect that the efficiency or intensity of the biological treatment process is increased as the growth of microorganisms is stimulated. Benefits with the proposed outlet pipe construction, which enables air injection also when high amounts of wastewater are added, include that the increase in the thickness of the layer of FOG on the surface of the wastewater over the period of e.g. a week is reduced, which in turn have the effect that the FOG cake needs to be removed from the container tank less frequently, e.g. by emptying the container. Other advantages of the technology disclosed include that the total amounts of microorganisms needed to be added to the biological treatments to sustain the biological treatment process is reduced as the growth of microorganisms is also sustained by the injection of air during periods when high amounts of wastewater are added to the biological treatment zone/container.

### BRIEF DESCRIPTION OF DRAWINGS

Embodiments of the invention will now be described in more detail with reference to the appended drawings, wherein:

FIG. 1 shows a container tank according to one or more embodiments. In the example embodiments illustrated in FIG. 1, essentially the whole inner volume of the container tank constitutes a biological treatment zone configured for both separating and breaking down fat, oil and grease.

FIG. 2 shows a container tank according to one or more other embodiments. In the example embodiments illustrated in FIG. 2, the container tank comprises a first zone adapted for separating heavy particles and substances from the wastewater and a second zone, a biological treatment zone, configured for separating and breaking down fat, oil and grease. Since the heavy particles and substance in the wastewater have a higher density than water, these particles and substances sink to the bottom of the first zone, to thereby form a sediment on the bottom of this zone. The container tank is preferably further configured so that the sediment formed on the bottom can easily be recovered and removed from this zone of the container

FIG. 3 shows an outlet pipe construction comprising two inlet pipe portions and an outlet pipe portion according to embodiments of the technology disclosed.

FIG. 4 illustrates an example embodiment of the technology disclosed where the central axes of the openings of the two inlet pipe portions of the outlet pipe construction are facing upwards at a certain angle α to the horizontal gravitational plane and the surface of the wastewater in the biological treatment zone.

FIG. 5 illustrate the same example embodiment of an outlet pipe construction as FIG. 4 from a different angle and when positioned in a container tank according to the technology disclosed. In FIG. 5, the openings of the two inlet pipe portions of the outlet pipe construction are facing upwards at a certain angle α to the horizontal gravitational plane and the surface of the wastewater in the biological treatment zone.

### DETAILED DESCRIPTION

As used herein, the term “wastewater” refers to a stream of waste, bearing at least one undesirable constituent capable of being converted by microorganisms, deliverable to the wastewater treatment system for treatment. More specifically, the undesirable constituent may be a biodegradable material, such as an inorganic or organic compound that participates or is involved in the metabolism of a microorganism. For example, the undesirable constituent may include nitrate, nitrite, phosphorous, ammonia, and the like, typically present in wastewater. The type and concentration of undesirable constituents present in the wastewater may be site-specific. Communities may establish regulations regarding these undesirable constituents. For the purposes of the present description, wastewater refers to what is fed to the system and what is treated throughout.

The technology disclosed addresses the problem with the disturbance that poisoning and degeneration of a bio-culture may cause, by suggesting a well-planned distribution of the bio-culture, to renew the colonies in the whole system continuously. The method of the technology disclosed has the purpose of separating separable fat, oil and grease (FOG) from wastewater and reducing the amount of separable FOG which needs to be taken care of. In the process, a specially equipped container tank is used. The equipment of the technology disclosed makes it possible to use the container tank simultaneously and concurrently as a separator and bioreactor. The separator function is a gravimetric separation process where FOG is collected in the usual way in the, for separated FOG intended, volume in the container. The bioreactor function provides for the FOG to be biologically broken down wholly or partly. To start the breaking down of FOG, a liquid culture of suitable microorganisms is added to a biological treatment zone of the container tank. In example embodiments, the culture of microorganisms includes at least one of living bacteria and fungi.

In the technology disclosed, the bio-culture is mixed efficiently with the content in the container by air injection improving the oxygenation conditions in the biological treatment zone. In example embodiments, the bio-culture may be mixed by air injection in a layer, or zone, that lays under a floating FOG layer in the FOG separator/bio-reactor. In other example embodiments, the bio-culture may be mixed by air injection in an intermediate layer that lays over a sludge layer and under a floating FOG layer in the FOG separator/bio-reactor. To maintain the biological process and intensify the break down and mixing, air is blown in using a system for injecting and distributing the air. The addition of a liquid starter culture containing a suitable mixture of living microorganisms, which are evenly distributed in the bioreactor with the aid of the air injection.

Thus, the bioreactor function is aimed at further reducing the concentration of FOG in the wastewater and is performed by the addition of a liquid culture of microorganisms. In example embodiments, the culture of microorganisms includes at least one of living bacteria and fungi. The growth of the microorganisms is increased by injecting air into the biological treatment zone for improved oxygenation and mixing of the wastewater. The method of the technology disclosed is adapted to increase the efficiency of the combined FOG separator and bioreactor process.

The air injection may have several purposes, including:
1. disintegrate the FOG layer to make the fat, oil and grease easily available for the microorganisms, i.e. increase the bio-availability of the FOG;
2. achieve efficient oxygenation;
3. achieve an even microorganism distribution by good mixing;
4. Even out pH-variations.

The combined process of the technology disclosed includes separating separable FOG from FOG containing wastewater and treating the FOG containing wastewater in a combined FOG separator/bioreactor. The FOG separator is a gravimetric FOG separator function for creating a layer of floating FOG, a hard cake of FOG, on the surface of the wastewater. The layer of FOG, or FOG cake, is removed from the FOG separator from time to time, thereby reducing the concentration of FOG in the wastewater flowing out from the FOG separator. Typically, the FOG cake may be removed from the container tank prior to the FOG separation process is no longer working as efficiently because the FOG cake has become too thick. In example embodiments of the technology disclosed, the FOG cake may then be removed by emptying the wastewater in the FOG separator together with the FOG cake. In other example embodiments of the technology disclosed, the FOG cake may be separately recovered and removed from the FOG separator without emptying all of the wastewater in the tank.

Today, a complete breakdown of fat in a combined fat separator and bioreactor is not achieved as the concentration of fat (e.g. defined by mg of hydrocarbons/I wastewater) flowing out of the fat separator is not allowed to exceed set limit values. This is largely due to that the time window within which the biodegradation process is allowed to be active, is limited to the times of the day (usually at night) when no, or low amounts of, wastewater is added to the fat separator.

Efficient biological breakdown of FOG is promoted by high bioactivity, which in turn benefits from high turbulence while efficient FOG separation is disadvantaged by the same high turbulence, as this counteracts the gravimetric FOG separation function in the container tank. The approach for improved oxygenation/aeration according to the method proposed by the technology disclosed, if implemented in existing container tanks for reducing the amount of fat in wastewater, may lead to a deterioration in the FOG separation efficiency during periods when high amounts of wastewater is added to the tank which, in turn, may lead to that the concentration of FOG, or a specific undesirable constituents of the FOG in the wastewater, e.g. hydrocarbons, in the wastewater flowing out from the container tank exceeds a certain limit, e.g. exceeds a specific threshold value set by the operator of the container system, the community or the authorities. In example embodiments of the technology disclosed, the threshold value for the concentration is set to a specific value between 10 and 100 milligrams of hydrocarbons per liter of wastewater.

The above-mentioned threshold value for the concentration of FOG, and/or specific undesirable constituents of the wastewater, may be set to avoid clogging in the pipe system receiving the wastewater from the container tank. As mentioned above, communities and authorities may also establish regulations regarding undesirable constituents. The undesirable constituent may be a biodegradable material, such as an inorganic or organic compound that participates or is involved in the metabolism of a microorganism. For example, the undesirable constituent may include nitrate, nitrite, phosphorous, ammonia, and the like, typically present in wastewater. The type and concentration of undesirable constituents present in the wastewater may also be site-specific.

The container, the outlet pipe construction and method according to the technology disclosed is adapted for allowing air injection during periods when high amounts of wastewater are added to the container tank, thereby improving the oxygenation conditions in the biological treatment zone of the container. The improved oxygenation conditions have the effect that the efficiency or intensity of the biological treatment process is increased as the growth of microorganisms is stimulated.

In example embodiments of the technology disclosed and depending on the size of the container tank used and/or the maximum volume of wastewater that may be contained in the container tank used, the high amounts of wastewater added to, or flowing into, the container tank may be defined by an average value within the range from 2 liters of wastewater per second to 20 liters of wastewater per second averaged over a continuous period of at least 20 minutes. In an example embodiment of the technology disclosed where a specific type of container tank adapted for containing a maximum volume of 3500 liters of wastewater is used, the averaged value for the high amounts of wastewater may be between 5 and 10 liters of wastewater per second.

In example embodiments of the technology disclosed and depending on the size of the container tank used and/or the maximum volume of wastewater that may be contained in the container tank used, the small inflow of wastewater added to, or flowing into, the container tank may be defined by an average value which is below a value within the range from 0.1 liters of wastewater per second to 1 liter of wastewater per second averaged over a continuous period of at least 20 minutes. In an example embodiment of the technology disclosed where a specific type of container tank adapted for containing a maximum volume of 3500 liters of wastewater is used, the averaged value for the small inflow of wastewater may be below 0.5 liters of wastewater per second.

An example container tank for containing a maximum volume of 3500 liters of wastewater may typically be adapted to be filled with wastewater within a period of 12 hours to 2 days, depending on application. However, for a specific application, the same container tank may be filled within a period lasting less than 15 minutes.

Benefits with the proposed method of further stimulating the growth of microorganisms by air injection also when high amounts of wastewater are added include that the increase in the thickness of the layer of FOG on the surface of the wastewater over the period of e.g. a week is reduced, which in turn have the effect that the FOG cake needs to be removed from the container tank less frequently, e.g. by emptying the wastewater in the container tank together with the FOG cake. Other advantages of the technology disclosed include that the total amounts of microorganisms needed to be added to the biological treatments to sustain the biological treatment process is reduced as the growth of microorganisms is also sustained by the injection of air during periods when high amounts of wastewater is added to the biological treatment zone/container. Depending on the size of the container tank used and/or the maximum volume of wastewater that may be contained in the container tank used, the high amounts of wastewater added to the container tank may, in example embodiments of the technology disclosed, be defined by a value within the range from 2 liters of wastewater per second to 20 liters of wastewater per second.

According to one or more embodiments of the invention, the wastewater treatment system of the present invention may be a bioreactor having one or more biological treatment zones. As used herein, the term “treatment zone” is used to denote an individual treatment region, which can be characterized as promoting, effecting, or exhibiting a type of metabolic activity or biological process. Multiple treatment regions or zones may be housed in a single container. Alternatively, a treatment region or zone may be housed in a separate container, wherein a different treatment is carried out in each separate container. The biological treatment zones may be sized and shaped according to a desired application and to accommodate a volume of wastewater to be treated. For example, hydraulic residence times of various unit operations of the treatment system may depend on factors such as influent flow rate, effluent requirements, concentration of target compounds in the influent stream, temperature, and expected peak variations of any of these factors.

In addition to the one or more biological treatment zones and in example embodiment, the container may also comprise a first zone adapted for separating heavy particles and substances from the wastewater. Since the heavy particles and substance in the wastewater have a higher density than water, these particles and substances sink to the bottom of this zone, to thereby form a sediment on the bottom of this zone, which may further be configured so that the sediment formed on the bottom can occasionally be recovered and removed from this zone of the container.

The biological treatment zone may contain a fluidizable media to host microorganisms. The treatment zone may be maintained at different conditions to enhance growth of different microorganisms. Without being bound by any particular theory, different microorganisms may promote different biological processes. For example, passing wastewater through denitrifying bacteria may increase the efficiency of a denitrifying process. Likewise, passing wastewater through nitrifying bacteria may increase the efficiency of a nitrifying process. The bioreactor may also comprise means for maintaining the fluidizable media within each treatment zone during operation. For example, a screen, perforated plate, baffle or fluid countercurrents may be used to maintain the fluidizable media within the biological treatment zone. In the example embodiments of a plurality of biological treatment, e.g. in a plurality of different containers, the fluidizable media may, but need not be, similar in each biological treatment zone.

Prior to normal operation, the system may undergo a period of start-up. Start-up may involve biomass acclimation to establish a population of microorganisms. Start-up may run from several minutes to several weeks, for example, until a steady-state condition of biological activity has been achieved in one or more biological treatment unit operations. In example embodiments, the culture of microorganisms includes at least one of living bacteria and fungi.

The bioreactor of the technology disclosed comprise a biological treatment zone. The biological treatment zone is an aerobic treatment zone, maintained at aerobic conditions to promote the growth and/or metabolic activity of microorganisms, e.g. aerobic bacteria. The term “aerobic conditions” is used herein to refer, in general, to the presence of oxygen. The microorganisms, or aerobic bacteria, may, for example, facilitate and/or enhance the efficiency of a nitrifying bioprocess in which ammonia is oxidized to form nitrite which is in turn converted to nitrate. The aerobic bacteria may also, for example, facilitate and/or enhance the efficiency of a phosphorous uptake bioprocess in which soluble phosphorous is restored to the microorganisms, or aerobic bacteria.

The technology disclosed describes a process and wastewater treatment equipment for separating separable fat, oil and grease (FOG) from wastewater and reducing the amount of separable FOG which needs to be taken care of, i.e. be removed from a tank containing wastewater. In the process, a specially equipped container tank is used. In embodiments, the technology disclosed further introduces a new design for the outlet pipe construction of the container for facilitating or enabling the container to simultaneously function as both a FOG separator and a bioreactor.

The addition of a culture of microorganisms according to the technology disclosed is used in a biological process, or bioprocess, for breaking down fat, oil and grease. In the technology disclosed, the microbe culture, e.g. a liquid microbe culture, is preferably added and distributed by injection of an oxygen-containing gas such as air into a biological treatment zone of a container for improved oxygenation. In various embodiments, the biological treatment zone may cover essentially the entire inner volume of the container or it may be a separate section or compartment of the container.

The technology disclosed further comprise a system adapted for injecting and distributing a high amount of oxygen-containing gas, e.g. air, per unit of time into the wastewater contained in the biological treatment zone to achieve a high bioprocess productivity, or a high bioprocess efficiency, during periods when no wastewater, or a small inflow of wastewater, per unit of time is added to the container.

The method of the technology disclosed further includes injecting a low amount of air per unit of time during periods when high amounts of wastewater per unit of time is added to the container, thereby enhancing the oxygenation conditions to increase the growth of microorganisms for improved biological activity and breaking down of FOG. The injection of low amounts of air per unit of time during periods when high amounts of wastewater are added to the container may be used to increase the growth of microorganisms for improved biological activity during periods when no wastewater, or a small inflow of wastewater, per unit of time is added to the container.

The injection of low amounts of air per unit of time during periods when high amounts of wastewater per unit of time is added to, or flowing into, the biological treatment zone is adapted to enhance the oxygenation conditions to stimulate an increase in the growth and concentration of microorganisms in the biological treatment zone also during periods when no or low amounts of wastewater per unit of time is added. By improving the oxygenation conditions also during periods when high amounts of wastewater per unit of time is added to the biological treatment zone, the biological activity and breaking down of FOG is more rapidly reaching higher levels during periods when no wastewater, or a small inflow of wastewater per unit of time, is added, i.e. faster reaction rates is achieved.

In example embodiments of the technology disclosed and depending on the size of the container tank used and/or the maximum volume of wastewater that may be contained in the container tank used, the high amounts of wastewater added to, or flowing into, the biological treatment zone of the container tank may be defined by an average value within the range from 2 liters of wastewater per second to 20 liters of wastewater per second averaged over a time period of at least 30 minutes.

In example embodiments of the technology disclosed and depending on the size of the container tank used and/or the maximum volume of wastewater that may be contained in the container tank used, the small inflow of wastewater added to, or flowing into, the biological treatment zone of the container tank may be defined by an average value within the range from 0.2 liter of wastewater per second to 1 liter of wastewater per second averaged over a time period of at least 30 minutes.

In embodiments, the transition between periods when high amounts of wastewater per unit of time is added and periods when no or low amounts of wastewater per unit of time is added may comprise the addition of a liquid culture containing a suitable mixture of living microorganisms, which are evenly distributed in the biological treatment zone with the aid of the air injection.

The injection of low amounts of air per unit of time during periods when high amounts of wastewater per unit of time is added to the biological treatment zone is adapted to enhance or improve the oxygenation conditions in the biological treatment zone. In embodiments, these improved oxygenation conditions have the technical effect that the total amounts of microorganisms that needs to be added to the biological treatment zone to achieve the same level of efficiency in the bioprocess for breaking down FOG may be reduced.

This new procedure according to the technology disclosed of injecting air also during periods when high amounts of wastewater per unit of time is added to the biological treatment zone stimulates an increase in the growth and concentration of microorganisms in the biological treatment zone, which in turn provide the technical effect that the addition of a liquid culture containing a suitable mixture of living microorganisms may be performed less frequently. In some embodiments of the technology disclosed, the addition of a liquid culture containing a suitable mixture of living microorganisms may be performed less frequently than once every 24-hour time cycle. In other embodiments, these improved oxygenation conditions provide the advantage that the addition of a liquid culture of microorganisms may be performed less frequently than once every 48-hour time cycle.

In example alternative embodiments, the addition of a liquid culture containing a suitable mixture of living microorganisms may be performed at least once during periods when no or low amounts of wastewater per unit of time is added. In alternative embodiments, the addition of a liquid culture containing a suitable mixture of living microorganisms may also be performed at least once during periods when high amounts of wastewater per unit of time is added to the biological treatment zone of the container. In yet other embodiments, the addition of a liquid culture containing a suitable mixture of living microorganisms may also be performed.

In the system and container of the technology disclosed, the gravimetric FOG separation function and the bioreactor function are both maintained at certain levels of activity over a 24-hour time cycle. When FOG containing wastewater is added, the system for injecting and distributing air into the biological treatment zone of the container is adapted to inject small amounts of air, thereby increase the growth of microorganisms for improved biological activity also during periods when no wastewater, or a small inflow of wastewater, per unit of time is added to the container. During periods when there is no, or low amounts of wastewater is added to the container, the function of the container is changed over to correspond to a modern bioreactor running at full scale and which achieves an intensive biological break down of all available organic material.

As mentioned above and in alternative embodiments, the container consists of two zones compartments or sections including a first zone, compartment or section adapted for separating heavy particles and substances from the wastewater and a second biological treatment zone for separating and breaking down FOG. Since the heavy particles and substance in the wastewater have a higher density than water, these particles and substances sink to the bottom of this first zone, compartment or section to form a sediment and the second zone, compartment or section may further be configured so that the sediment formed on the bottom can occasionally be recovered and removed from the first zone, compartment or section of the container.

The process and wastewater treatment equipment of the technology disclosed combines a conventional gravimetric FOG separator and a modern bioreactor in the same zone of a container, i.e. the biological treatment zone, for reducing FOG in wastewater. The biological treatment zone may be the whole volume of the container, or a separate compartment or section of the container may constitute the biological treatment zone, or bioreactor. According to the process and improved wastewater treatment equipment of the technology disclosed, these two separate processes of the gravimetric FOG separator and the modern bioreactor are concurrently and simultaneously functioning at a high efficiency level to reduce the amounts of FOG in the wastewater of the biological treatment zone.

An essential difference in comparison to earlier publications related to only separating fat from wastewater is that the air injection of the present invention does not solely concerns maintaining aerobic conditions. Instead the air injection must have enough intensity to achieve an improved oxygenation and efficient mixing in the whole bioreactor, including the layer of FOG/fat, i.e. the FOG cake, separated by the gravimetric FOG separation function. At the execution of this invention, which, inter alia, comprises elements for removing separated FOG from the container tank, e.g. by emptying the wastewater in the container tank, the air injection needs to be carefully controlled not to cause unwanted levels of turbulence in the wastewater. This means, inter alia, that the air injection needs to be limited to what is needed to both avoid an increase in the turbulence causing a significant decrease in the gravimetric FOG separation efficiency as well as an unpleasant smell. The method and container according to the technology disclosed, the injection and distribution of air is performed with enough intensity to cause effective oxygenation during an entire 24-hour cycle covering both time periods when high amounts of wastewater are added to the container and time period when no or low amounts of wastewater are added to the container.

According to example embodiments, the total amount of wastewater added to the container during at least one first period when high amounts of wastewater are added to the container is at least three times the total amount of wastewater added to the container during at least one second period when no wastewater, or a small inflow of wastewater, per unit of time is added to the container. The at least one first period for adding high amounts of wastewater per unit of time to the biological treatment zone may be defined by at least one period covering at least two hours in total of a continuous 24 hours period, or time window. The at least one second period when low amounts of wastewater are added to the biological treatment zone per unit of time may be defined by at least one period covering at least two hours in total over the same continuous 24 hours period. Depending on the size of the container tank used in accordance with example embodiments of the technology disclosed, typically between 2 and 20 liters of wastewater per second is received during periods when high amounts of wastewater per unit of time is added to the container tank.

The technology disclosed concerns a process for separating separable fat, oil and grease from wastewater and reducing the amount of separable fat, oil and grease which needs to be taken care of. At the process a specially equipped container, or container tank, is used. The equipment makes it possible to use the container both as a separator and a bioreactor. During the separator process, fat, oil and grease is collected in the usual way in the, for separated fat, oil and grease intended, volume in the container. In the bioreactor function, the fat, oil and grease is biologically broken down wholly or partly. To start breaking down a liquid culture of suitable microorganisms is added to the bioreactor function. The bio-culture is mixed efficiently with the content in the container by air injection. In example embodiments, an intermediate layer lays over ae sludge layer and under the floating fat layer in the fat separator/bio-reactor. In further example embodiments and to maintain the biological process and intensify the break down and mixing, air may be blown in during the entire time when no new wastewater is added to the container.

The system is very simple and reliable. It demands no control of pressure drop in pipes and is principally immune to disturbances due to choking in pipes and/or nozzles. Automatic operation control is easy to achieve with conventional guiding systems founded on, for instance, time or flow control.

The technology disclosed breaks through the prejudice regarding the need for solid surfaces for the microorganisms expressed in some of the earlier publications mentioned above. The system of the technology disclosed does not demand pre-treatment of the wastewater. Instead needed decomposition and elimination of fat, oil and grease for complete breakdown occur directly within the biological process under influence of the air injection.

The method and container tank, and outlet pipe construction of the technology disclosed are firsthand intended for use at restaurants and food industries. In such plants one has as a rule an operation pattern with a 24-hours rhythm comprising a shorter or longer period with addition of wastewater to the separator and a comparably long, continuous or coherent period without such addition. These periods may be clearly defined regarding time. The process of the technology disclosed is easy to adapt to this by arranging that relatively high amounts of air is injected during periods when no addition of waste water is done, and that relatively low amounts of air is injected during periods when no, or low amounts of wastewater is added to the container tank. The relatively low amounts of air is injected not to disturb the separator function by creating excessive turbulence in the wastewater. The state of the art operating pattern for a fat separator is that when the staff is leaving the plant and the water addition has ceased the injection of a bio-culture and air injection starts simultaneously. When the required amount of bio-culture has been added, this injection stops. The air injection continues until a new operation period in the restaurant or plant is beginning. Thus, during the periods when waste water is added the fat separator functions as a conventional separator and the fat layer respectively the sludge layers build up simultaneously as the bio-culture is diluted. When the operation is shut down for the day the functions are changed over to let the central parts of the fat separator work as a bioreactor, where the added microorganisms attack and break down the fat layer.

The process means a combination in the same container tank of a continuous FOG separator a low bioactivity function during the operating periods and a full-scale bio-rector function during the daily shut down. In other example implementations of the technology disclosed, the operation conditions do not include a daily shutdown. This may be the case at use in connections, where the operation continues on a 24-hour basis, as in industries with shift working and some real estates and public institutions.

Further the invention concerns equipment for completing a conventional FOG separator with the mentioned bioreactor function in a simple way. In its outline in example embodiments, this equipment comprises a system for adding liquid bio-culture and a system for air injection in the intermediate layer between the FOG layer and the sludge layer. Further suitable system for dosing bio-culture and steering the air injection should be added. For dosing of bio-culture a simple tube pump may be sufficient, as the addition can be done via an open pipe, which does not cause an appreciable pressure drop. If a system for pressurised air does not exist, an air pump or a ventilator, giving enough pressure, is needed, too.

A common fat separator consists of a container of suitable material. Usually, the container's length is larger than its width. As a rule, the container is divided in two to three compartments by transverse walls. The walls do not rise to the container's whole wet height. In the first compartment counted from the inlet a coarse separation of sludge takes place, in the following compartment break down and fat separation occurs. Usually the fat separator has a manhole at its upper side.

The volumes of the container tanks differ very much. The smallest ones may have a volume of just 25 liters. However, containers exist that combine the fat separation function with flow equalisation. Such container tanks may have volumes of 200 cubic meters or more. For very small container tanks the high amounts of injected air per unit of time in this disclosure may be 1 liter per minute. For larger containers, the high amounts of air in this disclosure may be as high as 2500 liters per minute. More usual intervals for the high amounts of injected air according to the technology disclosed and the volumes of the container tanks described in this disclosure lay between 10 liters per minute and 500 liters per minute. The air volume should be large enough to obtain a fast and good mixing and dispersion of the FOG layer. The required amount bio-culture per dosing may be between 10 ml and 4000 ml or more common between 10 ml and 1500 ml.

When high amounts of wastewater per unit of time is added, the system mainly acts as a conventional fat separator, yet the biological activity is maintained above a certain level by the injection of (low amounts of) air. During periods when no or low amounts of wastewater is supplied to the container, the function of the equipment is changed over to mainly correspond to a modern bioreactor. By injecting (low amounts of) air also during periods when high amounts of wastewater per unit of time is added to the tank according to the technology disclosed, a more intensive biological break down of all available organic material may be achieved. The transition may comprise the addition of a liquid starter culture containing a suitable mixture of living microorganisms, which are evenly distributed in the reactor with the aid of air injection.

The technology disclosed aims at increasing the biological activity (and hence the degradation or break down of fat, oil and grease (FOG)) with enhanced FOG separation by introducing the injection of oxygen-containing gas such as air for improved oxygenation/aeration also during periods of the day when wastewater is added to the combined gravimetric FOG separator bioreactor tank. In example embodiments, the oxygenation/aeration during periods of the day when wastewater is added to the tank is further enabled by the technology disclosed proposing a modified design of the outlet pipe construction of the tank, which improves the FOG separation ability to achieve a reduced concentration of FOG in the wastewater flowing out from the container.

By providing at last one inlet pipe portion positioned at an angle in relation to at least one of the horizontal gravitational plane and the surface of the wastewater contained in the container, e.g. in a biological treatment zone of the container, the outlet pipe construction of the technology disclosed is adapted to improve the gravimetric FOG separation efficiency in that FOG has a lower density than water and wastewater moving in a direction towards the surface contains higher amounts of FOG than wastewater moving in the opposite direction. Moreover, by positioning the inlet portion of the outlet pipe construction in an upwards facing angle, the outlet pipe construction is further adapted to provide for a longer median retention time for the wastewater in the biological treatment zone. The central axis of the opening of the at least one inlet pipe portion for the inflow of wastewater into said outlet pipe construction may be directed at an angle facing away from at least one of the direction of the inflow of wastewater into the container/biological treatment zone and the system for injecting and distributing air, thereby achieving a longer median retention time for the wastewater in the biological treatment zone to thereby further improve the gravimetric FOG separation efficiency in the biological treatment zone as it takes a longer time for the wastewater to reach the inlet portion of the outlet pipe construction.

Hence, the technology disclosed facilitates improved oxygenation/aeration by introducing injection of air, i.e. low amounts of air, also when high amounts of wastewater per unit of time is supplied to the tank, e.g. during the day-time, thereby a significantly increased bioactivity is subsequently achieved during periods of the day, e.g. during night-time, when the bioreactor is “powered at full power”, i.e. when no, or low amounts of, wastewater is supplied to the tank. In example embodiments and, optionally, depending on a threshold value for the concentration of hydrocarbons in the outflowing wastewater set to avoid clogging in the pipe system receiving the wastewater from the container tank, the improved oxygenation/aeration may be enabled by the technology disclosed by proposing a new design for the outlet pipe construction of a combined fat separator and bioreactor. The new design of the outlet pipe construction according to the technology disclosed comprises at least one inlet pipe portion adapted to be positioned facing upwards at an angle in relation to at least one of the horizontal gravitational plane and the surface of the wastewater contained in a biological treatment zone of the container tank, thereby being adapted for improving the gravimetric FOG separation capacity/function in the biological treatment zone.

In the gravimetric FOG separation process, the FOG is separated as a solid comparatively hard cake, i.e. a fat cake or FOG cake. When the FOG cake created on the surface of the wastewater in the container tank is so thick that the gravimetric fat separation process is no longer working efficiently, the FOG cake created on the surface of the wastewater needs to be removed, e.g. by emptying the container tank, so that the efficiency of the gravimetric FOG separation process can be kept at a sufficiently high level. By injecting low amounts of oxygen-containing such as air also during periods of a 24-hour time cycle when high amounts of wastewater are added to the container, the oxygenation conditions and growth of microorganisms is improved which in turn provides for an increased bioactivity in the container tank, particularly during periods when no, or low amounts of, wastewater is supplied to the container.

The increased bioactivity achieved by the technology disclosed provides the further advantage that the FOG cake in the container tank does not need to be removed from the container tank as frequently, e.g. by emptying the wastewater in the tank. As an example, in state of the art solutions the FOG cake may have to be removed at least once a month to avoid that the gravimetric FOG separation process is starting to work too inefficiently, whereas the technology disclosed provides the technical effect and advantage that the FOG cake, or fat cake, may need to be removed from the container tank as seldom as less frequently than once every second month, less frequently than once every 6 months or less frequently than once a year. In example embodiments of the technology disclosed, the FOG cake is then removed by emptying the wastewater in the container tank together with the FOG cake. In other example embodiments, the FOG cake may be separately recovered and removed from the surface of the wastewater in the biological treatment zone of the container tank without emptying all of the wastewater in the tank.

Further benefits of the increased bioactivity in the container tank provided by the technology disclosed, in addition to the lower frequency of emptying the container tank in the process of removing the FOG cake from the tank, include that the amounts of microorganisms added to the biological treatment zone and the frequency of adding microorganisms may be kept lower.

FOG that is not broken down/degraded by the microorganism or separated from the wastewater in the container follows the wastewater out of the container tank and into the pipe sewer system where it can cause clogging. Therefore, it is important that the concentration of FOG, or specific undesirable constituents of the wastewater, flowing out of the container tank and into the pipe sewer system is always kept below a certain threshold limit value. This threshold limit value for the concentration of FOG, or fat, allowed to flow out from the container tank may be a value, e.g. 50 milligrams of hydrocarbons per liter of wastewater, set by communities, local or governmental authorities or agencies. The FOG, or undesirable constituent, may be a biodegradable material, such as an inorganic or organic compound that participates or is involved in the metabolism of a microorganism. For example, the undesirable constituent may include nitrate, nitrite, phosphorous, ammonia, and the like, typically present in wastewater. The type and concentration of undesirable constituents present in the wastewater may be site-specific. Communities may establish regulations regarding these undesirable constituents.

The above-mentioned low amounts of injected air per unit of time during periods when high amounts of wastewater is added to the container may then be adapted so the accumulation of FOG and the FOG thickness increase in the layer of FOG in the biological treatment zone is keeping the thickness of the layer of FOG below a certain thickness threshold for a certain period of time, yet the injected air per unit of time may further be adapted so that the concentration of FOG, and/or specific undesirable constituents of the wastewater, flowing out of the container tank and into the pipe sewer system during periods when high amounts of wastewater is added to the container tank is always kept below a certain threshold limit value, e.g. below a threshold limit value set by communities, local authorities or governmental agencies. As an example, the threshold limit value for the wastewater flowing out of a specific type of container tank with a certain volume may be set to a specific value between 10 and 100 mg hydrocarbons per liter of wastewater. Communities and authorities may also establish regulations regarding undesirable constituents contained in fat, oil and grease (FOG).

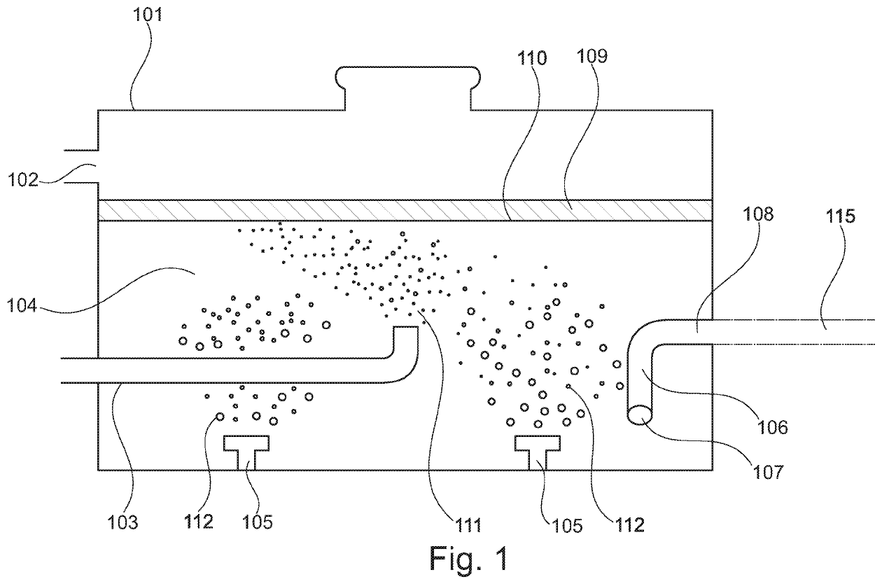

FIG. 1 shows a container tank 101 according to one or more embodiments. In the example embodiments illustrated in FIG. 1, essentially the whole inner volume of the container tank constitutes a biological treatment zone 104 configured for both separating and breaking down fat, oil and grease. The container tank comprises an inlet 102 for receiving wastewater and an outlet pipe construction 106 comprising two inlet pipe portions 107 and one outlet pipe portion 108. The outlet pipe construction 106 is adapted for leading wastewater into the two inlet portions 107 and out of the biological treatment zone and the container through the outlet portion 108. The wastewater flowing out of the biological treatment zone 104 and the container tank 101 is received by wastewater pipe system, or sewer pipe system, 115. The wastewater pipe system, or sewer pipe system, 115, which is not part of the container tank 101 of the present invention, is adapted for receiving wastewater flowing out from the container and other similar container tanks for reducing the amounts of fat, oil and grease which are connected to the wastewater pipe system 115.

The container tank illustrated in FIG. 1 comprises a distribution system 103 for adding a microbe culture of microorganisms 111 to the wastewater for biologically breaking down fat, oil and grease in the wastewater. The microbe culture of microorganisms 111 is added to the wastewater in the biological treatment zone 104 of the container tank. The container tank 101 in FIG. 1 further comprises an air injection and distribution system 105 for injecting and distributing oxygen-containing gas such as air 112 into the wastewater in the biological treatment zone 104 to achieve an efficient oxygenation and mixing of the wastewater to further increase the biological activity of the microorganisms 111 and the breaking down of fat, oil and grease in the biological treatment zone.

The container tank 101 in FIG. 1 is further adapted to provide for a process of separating fat, oil and grease in the biological treatment zone 104. In the process for separating fat, oil and grease from the wastewater a layer of fat, oil and grease 109 is formed on the surface of the wastewater 110 in the biological treatment zone 104. The layer of fat, oil and grease 109 is formed on the wastewater surface 110 in a gravimetric separation process in that fat, oil and grease has a lower density than water.

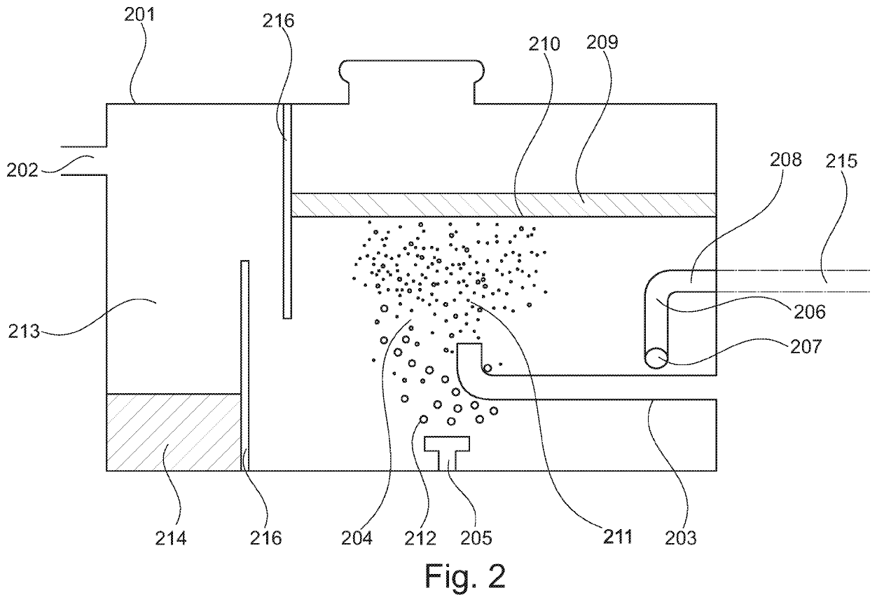

FIG. 2 shows a container tank 201 according to one or more other embodiments. In the example embodiments illustrated in FIG. 2, the container tank 201 comprises a first zone 213 adapted for separating heavy particles and substances from the wastewater and a second zone 204, a biological treatment zone 204, configured for both separating FOG from wastewater and biologically breaking down FOG. Since the heavy particles and substance in the wastewater have a higher density than water, these particles and substances sink to the bottom of the first zone, to thereby form a sediment 214 on the bottom of this zone. The container tank 201 is preferably further configured so that the sediment 214 formed on the bottom can easily be recovered and removed from this first zone 213 of the container tank.

The example embodiment of a first zone 213 for separating heavy particles and substances shown in FIG. 2 comprises two transverse walls 216 between the first zone 213 and the biological treatment zone 204. The transverse walls 216 are adapted for allowing for heavier substances and particles in the wastewater to sink to the bottom of the separator section to form a sediment 214, and in addition being adapted for allowing wastewater having a lower percentage of heavier substances and particles, compared to the percentage of heavier substances and particles in the wastewater received though said inlet, flowing out of the separator zone 213 and into the biological treatment zone 204.

The container tank 201 in FIG. 2 is further adapted to provide for a process of separating fat, oil and grease in the biological treatment zone 204. The container tank 201 comprises a distribution system (203) for adding a microbe culture of microorganisms (211) to the wastewater for biologically breaking down FOG in the wastewater, said microbe culture of microorganisms (111, 211) is added to the wastewater in a biological treatment zone (104, 204) of the container tank.

In the process for separating fat, oil and grease from the wastewater a layer of fat, oil and grease 209 is formed on the surface of the wastewater 210 in the biological treatment zone 204. The layer of fat, oil and grease 209 is formed on the wastewater surface 210 in a gravimetric separation process in that fat, oil and grease has a lower density than water. The container tank comprises an inlet 202 for receiving wastewater and an outlet pipe construction 206 comprising two inlet pipe portions 207 and one outlet pipe portion 208. The outlet pipe construction 206 is adapted for leading wastewater into the two inlet portions 207 and out of the biological treatment zone and the container through the outlet portion 208. The wastewater flowing out of the biological treatment zone 204 and the container tank 201 is received by wastewater pipe system, or sewer pipe system, 215. The wastewater pipe system, or sewer pipe system, 215, which is not part of the container tank 201 of the present invention, is adapted for receiving wastewater flowing out from the container and other similar container tanks for reducing the amounts of fat, oil and grease which are connected to the wastewater pipe system 215.

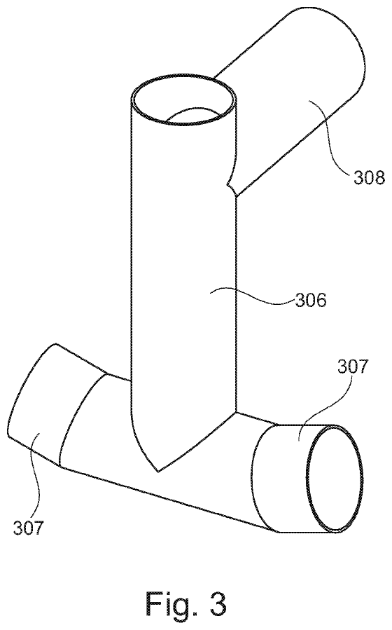

FIG. 3 shows an example embodiment of an outlet pipe construction 306 comprising two inlet pipe portions 306 and an outlet pipe portion 308 according to embodiments of the technology disclosed.

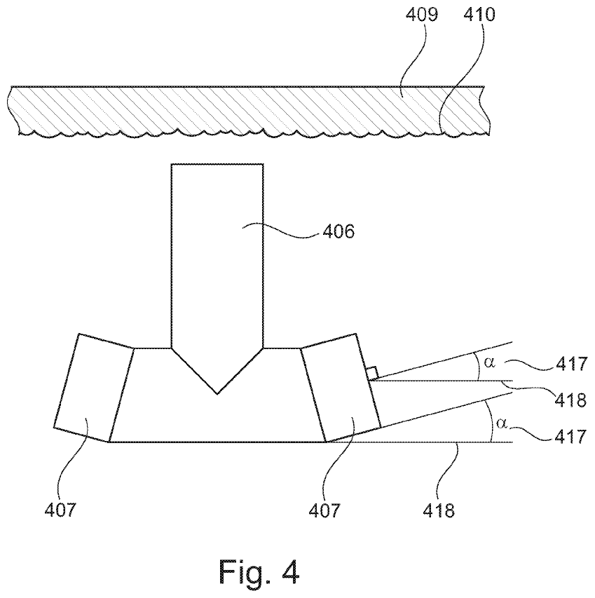

FIG. 4 illustrates an example embodiment of the technology disclosed where the central axes of the openings of the two inlet pipe portions 407 of the outlet pipe construction 406 are facing upwards at a certain angle α in relation to at least one of the horizontal gravitational plane 418 and the surface of the wastewater 410 in the biological treatment zone.

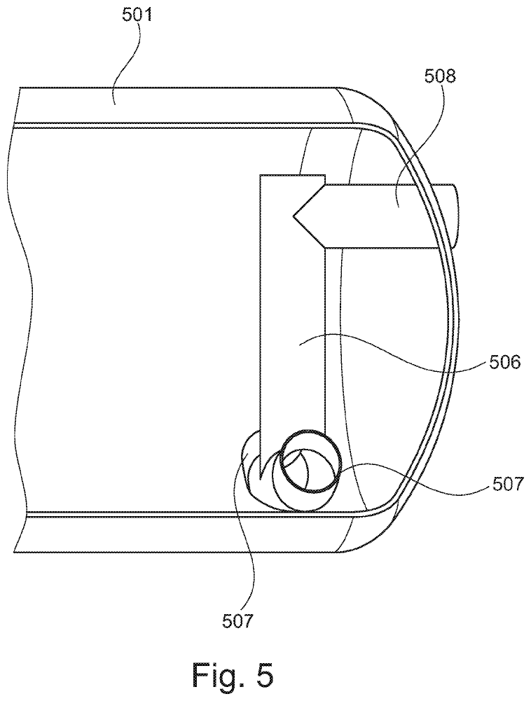

FIG. 5 illustrate the same example embodiment of an outlet pipe construction 506 as illustrated in FIG. 4 but from a different angle and when positioned in a container tank according to the technology disclosed. In FIG. 5, the openings of the two inlet pipe portions 507 of the outlet pipe construction 506 are facing upwards at a certain angle to the horizontal gravitational plane and the surface of the wastewater in the biological treatment zone.

The outlet pipe construction 106, 206, 306, 406, 506 illustrated in FIGS. 1, 2, 3, 4 and 5 is configured to improve the gravimetric FOG separation efficiency in that FOG has a lower density than water and wastewater moving in a direction towards the surface contains higher amounts of FOG than wastewater moving in the opposite direction. Moreover, by positioning the at least one inlet portions 107, 207, 307, 407, 507 of the outlet pipe construction in an upwards facing angle, i.e. at a certain angle α, e.g. within an angle range of 5-60 degrees, to the horizontal gravitational plane and the surface of the wastewater in the biological treatment zone in this embodiment, the outlet pipe construction is further configured to provide for a longer median retention time for the wastewater in the biological treatment zone. The central axis of the openings of the two inlet pipe portions for the inflow of wastewater into said outlet pipe construction may be directed at a perpendicular to the direction of the inflow of wastewater into the container/biological treatment zone and facing away from the system for injecting and distributing air, thereby achieving a longer median retention time for the wastewater in the biological treatment zone. This further improves the gravimetric FOG separation efficiency in the biological treatment zone as it takes a longer time for the wastewater to reach the two inlet portions of the outlet pipe construction.

Acid-resistant steel and fibre-reinforced plastic are usually considered as suitable material for the container tanks of the technology disclosed. Microbes thrive better at plastic surfaces than at acid acid-resistant steel. Fibre-reinforced plastic is preferred. When converting existing separators acid-resistant steel may be unavoidable. The intense mixing that the process according to the invention causes seems to eliminate the toxicity. This may be caused by the fact that the main part of the biologic activity occurs in the mixing zone. When suitable the toxicity of the acid-resistant steel may be eliminated by spraying with a suitable plastic. Another suitable material may be steel covered with plastic.

In embodiments, the air and distribution system 105, 205 may also comprise perforated plates for improved air distribution. Such plates may have perforations with holes between 0.1 and 10 mm. more usual and preferred is 1 to 5 mm. As the aeration does not solely concern oxygenation but also mixing the dimensions of the holes is not critical. Also, using plates is not necessary.

Perforated hoses or tubes are just as suitable. If the container tank has a horizontal surface large enough to cause danger for stagnant zones, the air injection should be done at several places distributed over the surface. In this way vertical circulation streams are obtained. The streams interfere with each other and cause that the content in the fat separator/bioreactor is homogenised. However, in the example embodiment of a container tank comprising a first zone in form of a separator for separating heavy particles and substances, the air injection may be limited to the biological treatment zone. The sludge layer in the coarse separator zone may then be left untouched. Of course, the sludge layer below the water zone will to large extent be whirled up at the air injection but experience has shown this to be no large drawback.

Microorganisms suitable for fat elimination are sensible for as well high as low pH. Optimal activity conditions can be found in the pH-range 6.5 to 8.5. Waste water from dish washing machines and other cleaning in restaurants and food processing industries often contains an alkali hydroxide. Surplus of fat and other reactive substances react fast with the alkali. At the inlet to the fat separator pH is seldom higher than 8 to 9. Thus, inlet-pH may be too high for optimal activity. However, this is no problem in a system where the bioactivity is optimised to let a substantial part occur during a daily shutdown. A larger problem has earlier been that acids are let free, inter alia, caused by the microbial activity and that pH therefore rapidly sinks to less than 6 and thus under the level suitable for optimal activity.

In example embodiments, pH-control and ph-stabilisation may be suitable. This concerns especially intensely loaded fat separators that may occur at some large restaurants. Glass electrodes may be used, but put high demands on supervising and cleaning. Measurement of conducting capacity can be used as a satisfactory alternative, after calibrations for each separate plant, and exhibits substantially fewer maintenance problems. Dosing devices governed by pH-control and adapted for suitable pH-stabilising chemicals should be installed in such plants.

Still another alternative that, beside pH-adjusting activity, improves the growth conditions for the microbe species is to add small amounts of ammonia to the air used for the oxygenation. The substrates for the microbes show low levels of available nitrogen and therefore the growth of biomass becomes better if ammonia is added. The addition may be done from a pressure container and be controlled by a suitably designed magnetic valve.

Beside the sensitivity for high and low pH the microbes are very sensitive to active chlorine. Thus, the use of chlorine containing cleaning agents must be avoided. However, the risk of poisoning is much lower at the process of the invention, as reacting with organic material in the dirt eliminates chlorine compounds rather fast. This causes that addition of chlorine compounds does not poison the microorganisms, if the addition does not happen in close connection with the changeover from fat separator function to bioreactor function. Optimal temperature for the microbes lies within the range 32 to 37° C. Fat separators are usually placed at low-temperature surroundings and some isolation of the tank may be suitable. Measures may be needed to prevent hot wastewater from increasing the temperature too much temporarily. If the temperature in the surroundings of the separator is too low means for warm keeping, for instance with the aid of electricity, should be installed.

In accordance with one or more specific embodiments of the present invention, the wastewater treatment system may strategically manage the concentration of oxygen in streams within the system to facilitate pollutant removal. Oxygen may be present in various forms within the bioreactor. For example, streams within the system may contain dissolved oxygen and/or oxygenated species, such as, but not limited to, nitrates and nitrites, any of which may either originate in the wastewater or be produced by biological processes occurring within the bioreactor.

Without being bound by any particular theory, the presence of oxygen may promote certain biological processes, such as aerobic biological processes, while inhibiting others such as anaerobic biological processes. More specifically, oxygen may interfere with portions of metabolic schemes involved in the biological removal of nitrogen. Oxygen may also interfere with release of phosphorous, which may in turn limit the uptake of phosphorous. Thus, in example embodiments comprising a plurality of treatment zones, delivering wastewater streams with a high concentration of oxygen to treatment zones where oxygen may promote biological activity, and reducing the concentration of oxygen in wastewater streams delivered to treatment zones where oxygen can interfere with biological processes, may be beneficial. Strategic management of the concentration of oxygen in streams within the wastewater treatment system may allow reduced equipment size, faster reaction rates and overall improved biological removal of pollutants.

As mentioned, the bioreactor may comprise multiple biological treatment zones. The bioreactor may in addition comprise a second type of biological treatment zone. In example embodiments, the container may also comprise this second type of biological treatment zone which is an anaerobic treatment zone, maintained at anaerobic conditions to promote the growth and/or metabolic activity of anaerobic bacteria. The term “anaerobic conditions” is used herein to refer, in general, to an absence of oxygen. The anaerobic bacteria may, for example, facilitate and/or enhance the efficiency of a phosphorous release bioprocess in which the bacteria may take up volatile fatty acids through a mechanism involving hydrolysis and release of phosphate.

The bioreactor may also comprise a third type of biological treatment zone. The third type of treatment zone may be an anoxic treatment zone, maintained at anoxic conditions to promote the growth and/or metabolic activity of anoxic bacteria. The term “anoxic conditions” is used herein to refer, in general, to a lack of oxygen. The anoxic bacteria may, for example, facilitate and/or enhance the efficiency of a denitrification process in which the bacteria may reduce nitrate to gaseous nitrogen while respiring organic matter.

1-40. (canceled)

41: A container tank for receiving wastewater and which is configured for both separating and biologically breaking down fat, oil and grease (FOG) to reduce the amount of FOG in the wastewater, said container tank comprising:
a) an inlet for receiving wastewater;
b) a distribution system for adding a microbe culture of microorganisms to the wastewater for biologically breaking down FOG in the wastewater, said microbe culture of microorganisms is added to the wastewater in a biological treatment zone of the container tank;
c) an air injection and distribution system for injecting and distributing air into the wastewater in the biological treatment zone to achieve an efficient oxygenation and mixing of the wastewater for increasing the biological activity and level of breaking down of FOG, wherein nozzles of the air injection and distribution system which are used for injecting air into the wastewater in the biological treatment zone are located at the bottom of the biological treatment zone; and
d) an outlet pipe construction comprising at least one inlet pipe portion and at least one outlet pipe portion adapted for leading wastewater into the inlet portion and out of the biological treatment zone through the at least one outlet portion, wherein said outlet pipe construction is arranged within the biological treatment zone so that the at least one inlet pipe portion is directed upwards at an angle α in relation to the surface of the wastewater to thereby be facing away from the nozzles of the air injection and distribution system located at the bottom of the biological treatment zone.

42: The container tank of claim 41, wherein said at least one inlet pipe portion is positioned at an upwards facing angle α in relation to the surface of the wastewater so that central axis of the opening of the at least one inlet pipe portion for inflow of wastewater into said outlet pipe construction is at an angle α within an angle range of 5-60 degrees in relation to at least one of the horizontal gravitational plane and the surface of the wastewater in the biological treatment zone.

43: The container tank of claim 41, wherein said at least one inlet pipe portion is positioned at an upwards facing angle α in relation to the surface of the wastewater so that central axis of the opening of the at least one inlet pipe portion for inflow of wastewater into said outlet pipe construction is at about 15 degrees angle α to at least one of the horizontal gravitational plane and the surface of the wastewater in the biological treatment zone.

44: The container tank of claim 41, wherein said outlet pipe construction is arranged so that central axis of the opening of the at least one inlet pipe portion of said outlet pipe construction is facing away from the inflow of wastewater.

45: An outlet pipe construction for use in a wastewater treatment tank for receiving and biologically breaking down and separating fat, oil and grease (FOG) in the wastewater, wherein the container tank includes an inlet for receiving wastewater, a distribution system for adding a microbe culture of microorganisms to a biological treatment zone for biologically breaking down FOG in the wastewater, and an air injection and distribution system for injecting and distributing air into the wastewater in the biological treatment zone to achieve an efficient oxygenation and mixing of the wastewater for increasing the biological activity and level of breaking down of FOG, where nozzles of the air injection and distribution system used for injecting air into the wastewater in the biological treatment zone are located at the bottom of the biological treatment zone, said outlet pipe construction comprising:
at least one inlet pipe portion; and
at least one outlet pipe portion adapted for leading wastewater out of the biological treatment zone,
wherein the outlet pipe construction is configured to be arranged within the biological treatment zone so that the at least one inlet pipe portion of said outlet pipe construction is directed upwards at an angle α in relation to the surface of the wastewater and facing away from the nozzles of the air injection and distribution system.

46: The outlet pipe construction of claim 45, wherein said outlet pipe construction is configured to be arranged so that central axis of the opening of the at least one inlet pipe portion of said outlet pipe construction is facing away from the inflow of wastewater.

47: The outlet pipe construction of claim 45, wherein said at least one inlet pipe portion is configured to be arranged at an upwards facing angle α in relation to the surface of the wastewater in the biological treatment zone of a container tank so that central axis of the opening of the at least one inlet pipe portion for inflow of wastewater into said outlet pipe construction is at an angle α within an angle range of 5-60 degrees to at least one of the horizontal gravitational plane and the surface of the wastewater in the biological treatment zone.

48: The outlet pipe construction of claim 45, wherein said at least one inlet pipe portion is configured to be arranged at an upwards facing angle α in relation to the surface of the wastewater so that central axis of the opening of the at least one inlet pipe portion for the inflow of waste water into said outlet pipe construction is at about 15 degrees angle α to at least one of the horizontal gravitational plane and the surface of the wastewater in the biological treatment zone.
